(19) United States
(12) Patent Application Publication
(10) Pub. No.: US 2005/0062888 A1
(43) Pub. Date: Mar. 24, 2005

(54) Apparatus and method for presentation of portably-stored content on an high-definition display

(76) Inventors: Anthony John Wood, Palo Alto, CA (US); Donald Robert Woodward JR., San Mateo, CA (US); Douglas Glen Shannon, Mountain View, CA (US); Daniel Sletten, Redwood City, CA (US); Patrick Michael Ellis, Redwood City, CA (US); Gregory Mack Garner, Springdale, AR (US); Michael Joseph Kobb, Belmont, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/665,978

(22) Filed: Sep. 19, 2003

(51) Int. Cl. H04N 11/00

(52) U.S. Cl. 348/553; 348/552

(57) ABSTRACT

An exemplary HD media player device and a method for presenting HD images to a user, according to a specific embodiment, include a controller configured to manage the processing of HD video signals to present images with a resolution similar to at least the 1080 i format. In one embodiment, the HD media player detects the presence of portably-stored content and then automatically performs a slideshow or any other multimedia performance. In another embodiment, HD media player includes a screen saver module.

### BRIEF DESCRIPTION OF THE INVENTION

The present invention relates to the presentation of multimedia. More particularly, the present invention relates to a media player and a method for presenting images to a user via a high-definition display, such as a high-definition television.

### BACKGROUND OF THE INVENTION

High-Definition (“HD”) display devices, such as HD televisions (“HDTVs”), use high-resolution video formatted signals to present images that are much clearer than images provided by traditional television signals formats, such as National TV Standards Committee (“NTSC”) or Phase Alternating Line (“PAL”) formats. Typical HDTVs can display images statically and/or dynamically at a resolution of at least 720 p or 1080 i, which is 1920 horizontal by 1080 vertical pixels. Although consumers of HD video are beginning to enjoy television broadcasts at this high-resolution format, they are unable to use their HDTVs to their fullest potential with conventional media players.

For example, conventional digital media players are designed for use with traditional televisions rather than HDTVs. These digital media players enable consumers to upload digitized photographs (or videos) from digital cameras via an inserted memory card (or over a network from a computing device) into these players for display on a television. Further, these digital media players allow consumers to add music (or other sounds) to create personalized multimedia slideshows. But these digital media players are generally designed to display digitized images in digital video disc (“DVD”)-quality resolution. DVD-quality resolution is usually described as 704 horizontal by 480 pixels. Consequently, conventional digital media players are not well suited for displaying images at HDTV resolutions.

With the growing popularity of sophisticated home entertainment centers, HDTVs are increasingly becoming a focal point at which family and friends congregate to socialize. As such, not only can an HDTV provide primary entertainment in the form of multimedia slideshows or digital jukeboxes, the HDTV can naturally provide background sights and sounds while family and friends engage in social discourse. In either case, the HDTV can be either inadvertently or intentionally left powered on over extended periods of time with no change in the displayed image. As most HDTVs are susceptible to fading and/or burnout (i.e., a detectable image has been burned onto the screen), an HDTV screen may lose its ability to present clear, crisp images after prolonged, static display of images.

In view of the foregoing, a media player capable of displaying images in high-definition video format is highly desirable. Ideally, the media player would be configurable to display images on an HDTV, would protect components of the HDTV and may or may not include other features not found in conventional digital media players, such as a mechanism for simplifying media player operation when portably-stored content is introduced into the media player.

### SUMMARY OF THE INVENTION

The invention includes a high definition media player and method for presenting high definition images from portably-stored content. In one embodiment of the invention, a media player comprises a high definition output terminal configured to communicate a high definition video signal to a high definition display, and a port configured to receive portably-stored content from a portable storage device. The exemplary media player can also include a controller configured to select an image file from the portably-stored content. The controller then generates at least a portion of a high definition image on the high definition display. In another embodiment, an exemplary media player includes a screen saver module configured to monitor the high definition video signal. In another embodiment, an exemplary media player includes a media insertion manager module to automatically present the portion of the high definition image to a user after the image file is discovered.

According to the present invention, an exemplary method of presenting a high definition image includes detecting the presence of portably-stored content and identifying that one or more media files are auto-run media files. Also, the exemplary method can include presenting on a high definition display at least one high definition image associated with the one or more media files. In another embodiment, an exemplary method includes identifying that no media file of the portably-stored content is an auto-run media file, and presenting on the high definition display at least one high definition image of the portably-stored content if the portably-stored content includes only image files.

### BRIEF DESCRIPTION OF THE FIGURES

The invention is more fully appreciated in connection with the following detailed description taken in conjunction with the accompanying drawings, in which:

FIG. 1 illustrates an exemplary HD media player in accordance with a specific embodiment of the present invention;

FIG. 2 shows an exemplary set of modules in accordance with at least one embodiment of the present invention;

FIG. 3 depicts a simple user interface showing an exemplary task view according to an embodiment of the present invention;

FIG. 4 illustrates a user interface showing an exemplary browser view according to one embodiment of the present invention;

FIG. 5 illustrates a user interface showing another browser view according to one embodiment of the present invention;

FIG. 6 is a flow diagram representing exemplary operation of a media insertion manager in accordance with an embodiment of the present invention;

FIG. 7 is an example of a user interface for providing feedback as to HD media player activity after insertion of portable-stored content, according to one embodiment;

FIG. 8 is an example of a user interface for providing additional feedback as to indicate to the user that a user input can be accepted, according to one embodiment;

FIG. 9 shows another task view of FIG. 3, according to one embodiment;

FIG. 10 illustrates yet exemplary another task view of FIG. 3, according to a specific embodiment;

FIG. 11 shows another task view of FIG. 4, according to another embodiment; and

FIG. 12 is a screen shot showing a scene of programmatically generated animation according to one embodiment.

Like reference numerals refer to corresponding parts throughout the several views of the drawings.

### DETAILED DESCRIPTION OF SPECIFIC EMBODIMENTS

The present invention provides a number of HD media player devices, as well as methods for presenting HD media, which includes images and audio, to a user. An exemplary high-definition (HD) media player, according to a specific embodiment, includes a controller configured to manage the processing of HDTV data signals to present static images, dynamic images (i.e., a sequence of images depicting movement) and/or a combination thereof with a resolution at least commensurate with the 1080 i format. A high-definition media player, as described herein, can be further configured to maintain the quality of an HDTV screen (or display) by at least minimizing fading and/or burnout. According to the present invention, the HD media player is designed to present and to facilitate manipulation of HD images for presentation individually, or as a part of a slideshow performance. Moreover, the HD media player can play high-quality music or other sounds optionally with photographs, or with a computerized visualizer for generating HD images programmatically. “High-quality audio” can refer to music or sound produced according to 5.1 multi-channel surround audio format, for example.

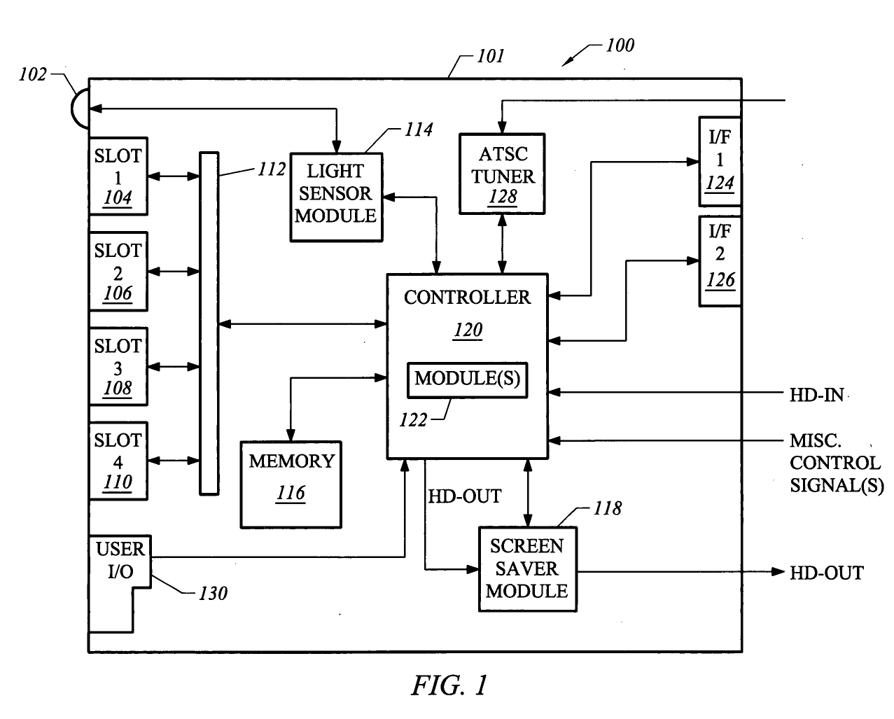

FIG. 1 illustrates an exemplary HD media player in accordance with a specific embodiment of the present invention. HD media player 100 includes a housing 101 enclosing at least a controller 120, one or more media slots 104, 106, 108 and 110, a screen saver module 118 and a light sensor module 114. Controller 120 is configured to receive data signals representing HD images (“HD-IN signal”) and to generate, process, and/or output data signals representing HD images (“HD-OUT signal”). An HD-OUT signal can be an HDTV data stream representing images of an HDTV broadcast signal and/or HD image data from any source of HDTV images.

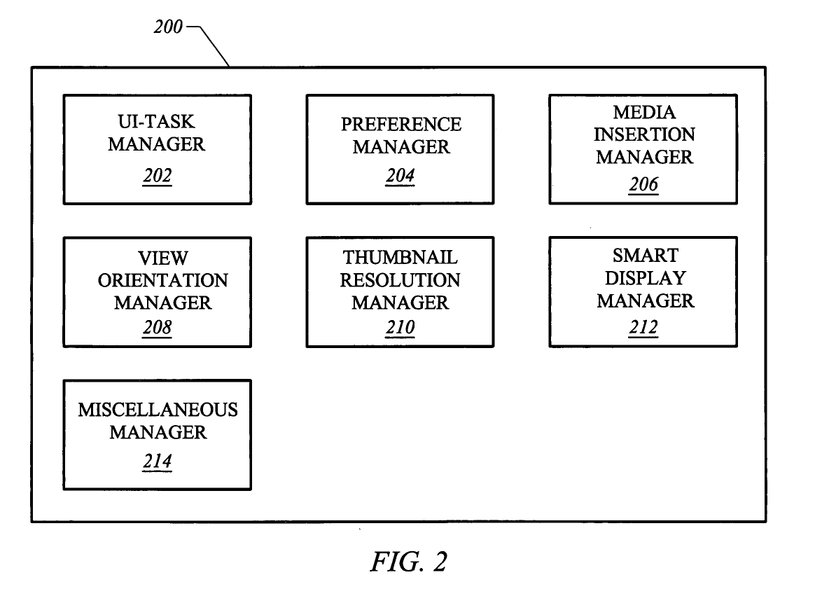

HD media player 100 is coupled to screen saver module 118 to at least receive data indicating whether an HD-OUT signal should be replaced with screen saver image data as the HD-OUT signal. In one embodiment, this HD-OUT signal can be a “pass-through” video signal or a “screen saver image” video signal generated by controller 102. The screen saver image video signal includes motion art, graphic images, etc., as well as any user interface (“UI”) element and/or image as generated by UI-Task manager 202 of FIG. 2. In this example, screen saver module 118 can provide two distinct user-selectable features for operating HD media player 100 in two modes.

Screen saver module 118 provides these two modes of operation as: (1) an auto-bypass mode and (2) a no-motion detect mode. In auto-bypass mode, screen saver module 118 allows HD-IN signals to be communicated substantially as HD-OUT signals. That is, screen saver module 118 does not alter operation of HD media player 100 until there is an absence of HD-IN signal. When screen saver module 118 detects that the HD-IN signal is absent, it operates to switch HD-OUT from HD-IN to a signal displaying a screen saver image generated by HD media player 100 (e.g., such as a UI display). For example, if a TV broadcasted HD image is input as an HD-IN signal into HD media player 100, screen saver module 118 allows the signal to pass-through. But if the video signal goes away, the HD media player 100 will automatically switch from outputting a pass-through video signal (e.g., HD-IN) to a screen saver image. When HD-IN is again detected as being present (regardless of whether the video depicts motion), then HD media player 100 switches from displaying the screen saver image to the TV broadcasted HD image as a “pass-through” signal.

In no-motion detect mode, however, screen saver module 118 operates to detect whether an active HD video signal has negligible motion, and if negligible motion is detected, then screen saver module 118 switches from passing-through HD-IN as HD-OUT to displaying an image generated by controller 120. That is, a screen saver image video signal is output as a HD-OUT signal. In one embodiment, the threshold at which a displayed image is deemed to have “negligible motion” is a percentage (e.g., user-defined) of the HDTV screen that does not have sufficient motion (e.g., changes in pixel values).

An exemplary interval of detection can be up to 10 minutes, or any interval that minimizes or prevents conditions for fading and/or burnout. An example of a case 1 situation is where the user has turned off a video input device, such as a satellite receiver. After screen saver module 118 detects either no substantial active video signal (i.e., the absence of video) or no motion, depending upon which mode is screen saver module 118 is configured to operate (i.e., auto-bypass mode or no-motion detect mode), then screen saver module 118 instructs controller 120 to substitute the HD-OUT signal with a signal representing one or more screen saver images, which can be in a slideshow format with or without audio. An example of this is when the user pauses the display of an image, and then that image is continually displayed up to the end of the detection interval. A screen saver image can be of any image type, such as MPEG, JPEG, or the like. For example, a screen saver image can be an HD MPEG video generated programmatically to render a life-like fish tank. In one embodiment, screen saver module 118 is configured to instruct the controller 120 to reduce the size of the screen saver image to, for example, 70% of its original dimensions. Then the display of this reduced screen saver image is moved, from time to time, under control of controller 120, to various portions of the HD display so as to provide motion to each of the display pixels thereby protecting the HD display from burnout, etc. The size, the rate at which the image is moved, and the like can be defined by a user.

HD media player 100 is coupled to light sensor module 114 to receive data indicating the level of luminance (or brightness) of light at photo sensor 102. Light sensor module 114 is configured to detect one of at least 16 to 256 different levels of ambient light, for example, where the one detected level indicates the brightness of light illuminating the surroundings of the HDTV display, and especially at photo sensor 102. In response to the detected level of ambient light, light sensor module 114 can instruct controller 120 to adjust HD-OUT so that the brightness level of the HDTV display is optimal for viewing, and in some cases, optimal for minimizing any negative effects of showing HD images at relatively high levels of brightness. In one embodiment, the selection of images (e.g., digital photos and videos) can be determined by the level of detected brightness, especially if a screen saver is activated. For example, at low brightness levels, nocturnal images of the moon, stars, and the like are displayed whereas at high brightness levels, daytime images of the sun, etc. are presented as screen saver images.

Sources of HDTV images include local memory 116, which is coupled to controller 120, remote computing devices or storage accessible via interfaces one 124 and two 126, and portably-stored content accessible via any one of media slots 104, 106, 108 and 110. A source of HDTV images can also be an email attachment, a personal computer file directory, a remote computer serving web-cam images, a compact disk, a DVD, or the like. Portably-stored content includes media files containing image and/or audio data (e.g., MP3 music files, WMA files, etc.) and can reside on or in any known portable storage device, such as a compact flash card (e.g., CF Type I, CF Type II or the like), a SmartMedia™ card, a Secure Digital (SD) or MultiMedia (MM) Card (either of which can be denoted as “SD/MMC”), a Memory Stick, XD, or any other suitable media adapted to receive data from digital cameras, personal digital assistants, mobile phones, electronic musical instruments, voice recorders, printers, scanners, and the like.

Controller 120 is coupled via bus 112 to slot one 104, slot two 106, slot three 108 and slot four 110, from which HD media receiver 100 receives portably-stored content, such as HD images, audio, and the like. Each of these slots can be designed to receive image data from any of the above-described portable storage devices. These slots can be any type port for receiving data electro-magnetically, mechanically, optically, or the like, from any type of portable storage device. In one embodiment, slot one 104, slot two 106, slot three 108 and slot four 110 are adapted for receiving a compact flash card, a SmartMedia™ card, a SD/MMC, and a Memory Stick, respectively. In another embodiment, all of these slots are located on one surface of housing 101, preferably the one surface most readily accessible to a user. Controller 120 is also coupled to memory 116 to at least receive locally stored content. In one embodiment, memory 116 also stores boot and program code for execution by controller 120. Memory 116 can include one or more 32 Mbytes double date rate random access memory (“DDR RAM”) devices, or any other device using a suitable memory technology.

As shown in FIG. 1, controller 120 is coupled to interfaces one 124 and two 126 to at least communicate with remote computing devices or storage, as well as other similar HD media players. Controller 120 can receive content from these external entities using any one of interfaces one 124 and two 126, and can also receive other types of miscellaneous signals, such as control signals for synchronizing the display generated from HD media player 100 and other similar HD media players (e.g., all HD media players are interconnected to form an array of HDTVs). In one embodiment, interface one 124 is a serial communications ports, such as an RS-232-compliant port, and interface two 126 is a TCP/IP-compliant port, such as an Ethernet interface. Notably, interface two 126 as a TCP/EP-compliant port can be adapted to communicate wirelessly, such as according to 802.11b/a/g or like standards. These two interfaces allow external control of HD media player 100 without using manual or infrared remote controls.

HD media player 100 can also include one or more user input devices, such as an infrared remote control (not shown) or a user I/O 130 on the surface of housing 101. The user I/O 130 can be a set of buttons, which include “navigate left,” “navigate right,” “navigate up,” “navigate down,” “select,” “menu,” and the like. Using these buttons, the user can guide the presentation of portably-stored content shortly after a card or other storage medium is inserted into one of slots 104, 106, 108, and 110.

In one or more embodiments, any of the following features can be implemented with an HDTV media player of the present invention. In one example, digital processing circuitry is included in HD media player 100 for using digitized audio signals to generate “visualizer-type” displays, which are computer-generated images having visual characteristics based on characteristics of an audio signal. In another example, controller 120 is a central processing unit configured to decode at least HD MPEG video data, and is further configured to support resolutions at 1080 i, 720 p, 480 p, 480 i or other like formats. In yet another example, controller 120 includes ATSC Tuner 128 for receiving HDTV broadcast signal formats as defined by the Advanced Television Systems Committee.

FIG. 2 shows a set of modules 200 corresponding to module(s) 122 of controller 120 of FIG. 1. Modules 200 perform and/or manage various subprocesses contributing to the overall functionality of an exemplary HD media player in accordance with the present invention. Each module of set of modules 200 can be implemented in hardware, software, or a combination thereof. But contrary to what is depicted in FIG. 1, any module of set of modules 200 can also reside external to controller 120, or alternatively can be distributed over two or more elements within HD media player 100 of FIG. 1. In this example, set of modules 200 includes a user interface (“UI”)-task manager 202, a preference manager 204, a media insertion manager 206, view orientation manager 208, a thumbnail resolution manager 210, a smart display manager 212, and at least one miscellaneous manager 214.

UI-task manager 202 controls the display of graphical information via an HDTV display. UI-task manager 202 accepts user inputs from, for example, an infrared remote control and presents to that user actions for either querying the functional state of an HDTV media player or executing one or more commands. For example, UI-task manager 202 provides graphical information to enable a user to select any media file containing content or any specific storage device that includes such content. Moreover, UI-task manager 202 enables a user to view and/or listen to any specific media file, to manipulate a media file (e.g., rotating an image), and to launch a photo viewer application or an audio player application individually, or in combination, as a part of a slideshow.

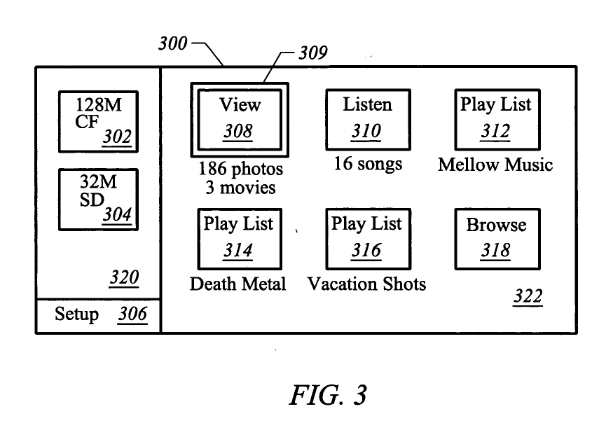

FIG. 3 shows an exemplary task view 300 as a simple user interface according to one embodiment of the present invention. Side pane 320 presents a selectable icon for representing each of two storage devices, a 128 Mb compact flash (“CF”) card 302 and a 32 Mb Secure Digital (“SD”) card 304. Side pane 320 can also include icons for selecting media files from local memory 116 of FIG. 1, remotely-networked computing devices, web-based Internet servers, etc. Main pane 322 includes one or more selectable tasks, such as “View” task 308, “Listen” task 310, “Play List” tasks 312, 314 and 316, and “Browse” task 318, that can be performed on the media files available to an HD media player of the present invention. A user selects “Setup” 306 to invoke preference manager 204 for configuring the functionality of an exemplary HD media player. For example, a user can select setup 306 to enable automatic copying of images from an inserted portable storage device.

View task 308, when selected, causes UI-task manager 202 of FIG. 2 to launch a format-appropriate photo (or video) player to display images of a specific storage device or folder. In this instance, View task 308 is shown with border 309 (or with a highlighting color, or any other distinguishing feature) to indicate that task is selected for execution. Listen task 310, when selected, prompts UI-task manager 202 to invoke a format-appropriate audio player, such as an MP3 player, to play audio of a particular media file. By selecting any of Play List tasks 312, 314 and 316, a user can cause UI-task manager 202 to perform a slideshow. For example, if a user selects Play List task 316, associated images of various “Vacation Shots” will be presented in the form of an HD slideshow, which can be accompanied by music. A user selecting Browse task 318 can cause UI-task manager 202 to invoke a photo browser and/or a music browser application for perusing, and optionally manipulating, media files of a specific content source (e.g., CF card 302). In some embodiments, Browse task 318 is presented as an item of a menu if a user selects a specific storage device in side pane 320.

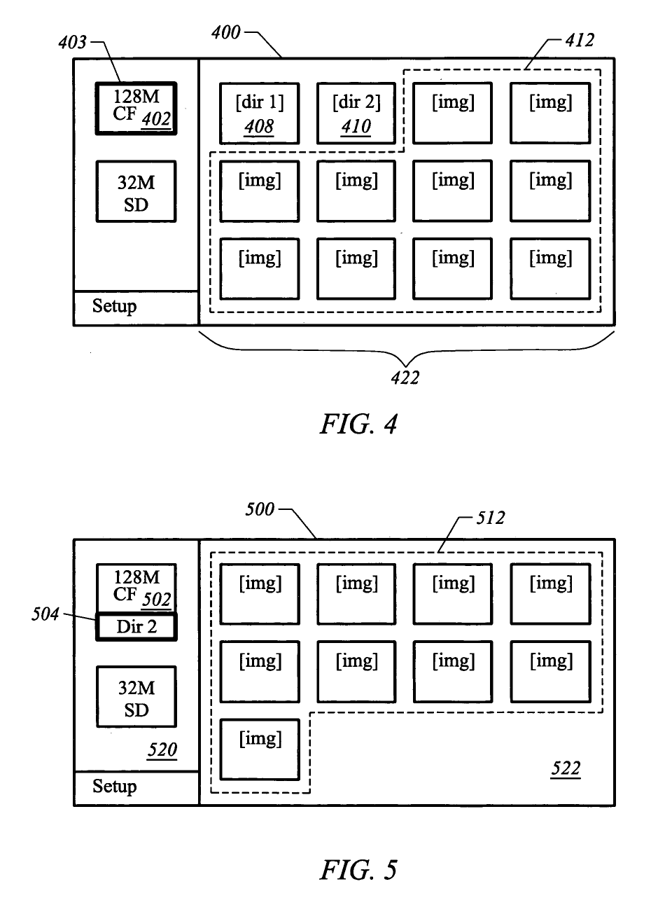

FIG. 4 is a user interface depicting an exemplary browse view 400 according to one embodiment of the present invention. In this example, a user selects to browse CF card 302 of FIG. 3. As shown in FIG. 4, CF card 302 is shown selected as CF card 402 with border 403 to indicate to the user that it has been selected. Main pane 422 presents to the user the contents of CF card 402, including two directories, “dir 1” 408 and “dir 2” 410, and several thumbnails 412 (each labeled as “img”). Each thumbnail 412 is an icon displaying a miniaturized view of the photo and/or video that the thumbnail represents. Using UI-task manager 202 of FIG. 2, a user can navigate among the thumbnails to select a particular image, and then interact with that particular image. Examples of interactions can include viewing full-screen, rotating, zooming, panning, deleting, copying to another card or computing device, etc. These interactions with a specific image can be either temporary or permanent. For example, a user can rotate an image by 270 degrees such that a later display of that image will be rotated.

UI-task manager 202 supports browser navigation of media files arranged in a flattened file structure having no hierarchical arrangement. This allows a user to browse some portably-stored content from devices that do not store media files in a hierarchical (e.g., “folder”) file structure. But in some embodiments, UI-task manager 202 can also support browser navigation of media files arranged in a hierarchy of directories, such as a folder-based file structure.

FIG. 5 is a user interface for displaying an exemplary browser view 500 according to one embodiment of the present invention. Further to the example described in connection with FIG. 4, a user selects to browse the hierarchically-arranged contents of directory two 410 {“[dir 2]”) of FIG. 4. As shown in FIG. 5, a selected subdirectory 504 of CF card 502 in side pane 520 is changed to show that the user is currently browsing a subdirectory, namely “dir 2” 410 of FIG. 4. After selection, main pane 522 of FIG. 5 displays the contents of subdirectory 504, including at least displayed thumbnails of images 512.

Returning to FIG. 2, preference manager 204 of set of modules 200 is configured to apply user-defined preferences to govern the manner in which images and audio are presented. For example, a user can select whether to present images and/or audio files by cycling through each file only in a specific directory or only in a specific subdirectory. Preference manager 204 can also (1) set a display resolution for one or more pictures, (2) specify types and lengths of transitions between image display (e.g., fade from one image to the next over 0.5 seconds; or cross-dissolve, simple switch, slide, etc.), (3) disable photo sensor 102 (or light sensor module 114) of FIG. 1 if the sensor is obstructed, (4) create a play list of images and/or audio such that the play list preferences can cause play list items to cycle based on time, date, brightness level, holiday, and/or randomness, (5) employ pan or zoom effects to an image (e.g., a high-resolution JPEG of a crowded street can be used to zoom from the view of a crowd to an individual during a user-defined interval), (6) select as a screen saver any combination of images and/or sounds, including looping a video clip (e.g., , until manually changed or a protective threshold is met to maintain HDTV display quality), (7) auto-advance each image of a slideshow after specified delay (e.g., configurable to be on/off, 5, 10, 20, 60 second delay, etc.), (8) display images in a slideshow in accordance with a user-defined order rather than by creation date, which is the default manner of ordering images for display, and/or any other like preferences for configuring operation of any HD media player according to the present invention.

Media insertion (“MI”) manager 206 operates to at least detect an insertion of at least one card into one of slots 104, 106, 108, and 110 of FIG. 1, analyze the contents of at least one portable storage device, and determine whether to launch a performance of images and/or audio or to present a task view user interface. According to the present invention, MI manager 206 is designed to automate the presentation of multimedia images and/or audio using a predetermined flow, which can optionally be modified in response to inputs from a user. In particular, MI manager 206 operates to determine whether a media file is an “auto-run” file. An auto-run file can be an image file (including image data) or an audio file (including audio data) that when detected, causes the HD media player to automatically present associated images and/or audio to a user. In one embodiment, an auto-run file is indicated as such by a flag. In another embodiment, an auto-run file is discovered by code on the portable stored device that is activated upon insertion, or alternatively, in response to a query from the HD media player.

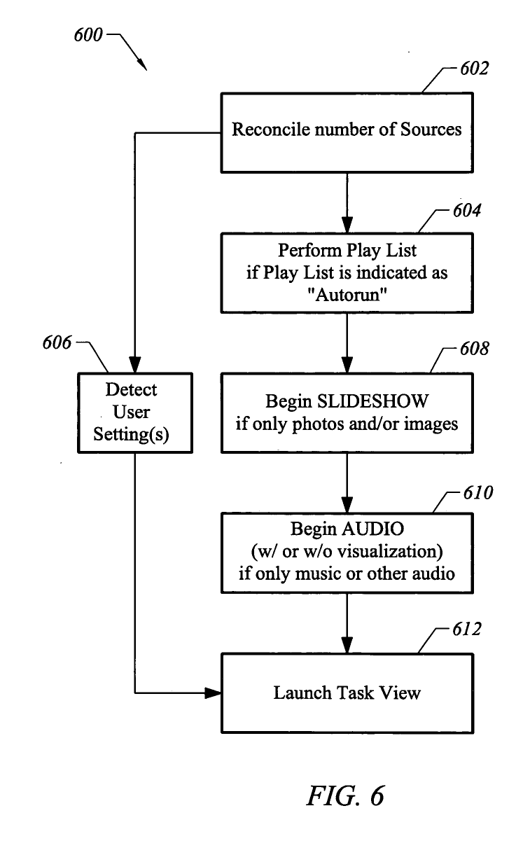

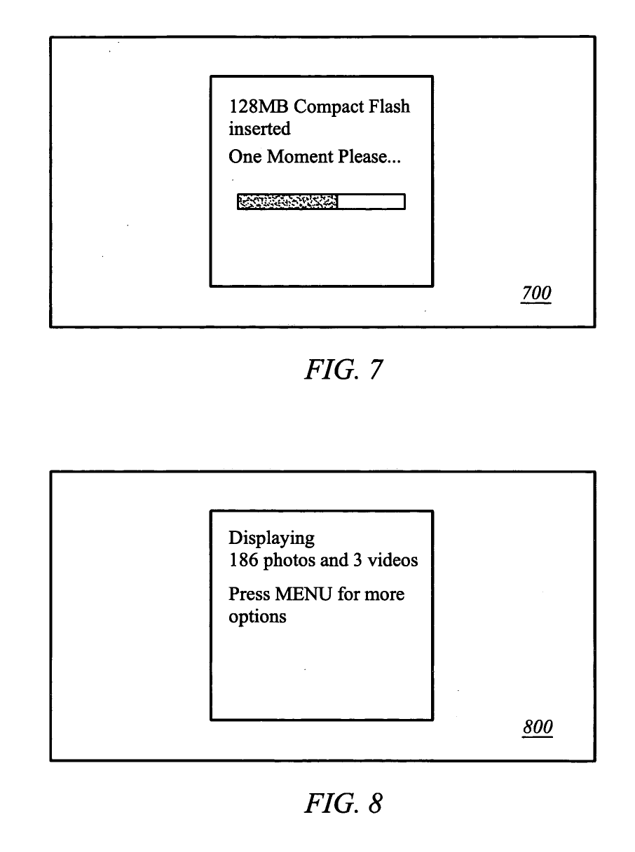

FIG. 6 is a flow diagram representing exemplary operation of MI manager 206 in accordance with one embodiment of the present invention. At block 602, MI manager 206 of FIG. 2 determines the number of sources inserted into the slots for receiving portable storage devices, which are removable from the HD media player of the present invention. For each portable storage device inserted, the user is presented with feedback as to the progress of reading and optional loading of content from each of the portable storage devices. FIG. 7 is an example of a user interface 700 for providing feedback to the user as to the activities of an exemplary HD media player, according to one embodiment. In this example, user interface 700 informs the user that a compact flash card has been inserted into a slot. If other cards are inserted in other slots, similar user interfaces can be shown to the user, for example, in a serial manner. In another embodiment, a user can define how to process multiply inserted portable storage devices. For example, consider that a user has selected a preference for loading audio files before loading image files. Consequently, the audio files will be loaded first at block 602 under the control of MI manager 206, which then continues through blocks 604 to 612. Thereafter, the lower prioritized image files can then be accessed for downloading.

At block 606, MI manager 206 determines whether the user has selected a preference for overriding the default behavior of MI manager 206. The default behavior in this example is to automatically launch into performing an image and/or an audio play list, which includes media files designated as “auto-run” files. If user preferences have been set to override the default functionality, MI manager 206 will instruct UI-task manager 202 to launch a task view, such as shown in FIG. 3, at block 612. Otherwise, MI manager 206 will proceed to block 604. Regardless, MI manager 206 continually determines to monitor user settings, including user inputs entered during flow 600.

At block 604, MI manager 206 scans image and audio files to determine whether any one file or a group of similar files (i.e., either all image or all audio) are indicated as an “auto-run” play list. By default, auto-run files are launched directly by MI manager 206 as these files are generally inserted to provide an immediate visual (and audio) performance on an HDTV display. For example, portably-stored content including “artwork” images, such as movie posters, classic paintings, people and nature photos, “nature-in-motion” images, such as a lake with ripples, forest with wind, earth from space, logs on fire, time-lapse clouds, etc., as well as other images are created for enjoyment in a user's HDTV-based entertainment system. Hence, MI manager 206 will assign a higher priority to these files for presentation.

Continuing with the previous example, the user has indicated a preference for launching audio files before image files. But if MI manager 206 detects an auto-run image file, then the auto-run image file takes precedence for display. FIG. 8 is an example of a user interface 800 for providing additional feedback to indicate to the user that a user input can be accepted, namely by pressing “MENU” to launch the task view, according to one embodiment. As shown in FIG. 8, UI-task manager 202, in response to a request from MI manager 206, indicates that it will begin displaying some auto-run files. But if the user enters an input that launches the task view, then the process flows directly to block 612.

Consider that no auto-run files are found. Then, MI manager 206 will begin presenting a slideshow of images only if selected portably-stored content includes only photos and/or videos. Otherwise, the operation of MI manager 206 flows to block 610. Here, MI manager 206 will begin presenting music or other sounds (e.g., nighttime sounds of crickets, etc.) optionally with a visualizer (or other images) only if selected portably-stored content contains only music and/or sounds. Otherwise, the operation of MI manager 206 flows to block 612 to launch the task view. After flowing to block 612 from blocks 608 and 610, MI manager 206 has determined that a mix of images and audio files exists in the selected portably-stored content. Consequently, the user will be prompted to provide input as to how the HD media player should handle this mixed content.

View orientation manager 208 of FIG. 2 is designed to control an orientation of an image as a user views it. First, a displayed image orientation may be suboptimal, for example, if a user captures an image while the camera is at 90 degrees (or 270 degrees) to the horizon. Hence, the captured image will be presented in an improper orientation for viewing. Second, a user might choose to rotate its flat panel HDTV into a “portrait” orientation. Consequently, most images will be displayed at 90 degrees from the horizon, making for suboptimal viewing of such images. View orientation manager 208 operates to orient images correctly regardless of these conditions contributing to suboptimal orientation.

In the former case, view orientation manager 208 monitors data representing an image (or accompanying the image) to detect whether a camera capturing the image embedded (or attached) an indicator (e.g., one or more flags) to the file of that photo. Typically, the indicator will represent a displacement of 90, 180, or 270 degrees from the horizon. If view orientation manager 208 detects a rotation from the indicator, then view orientation manager 208 will adjust the orientation accordingly for proper display. Similarly, view orientation manager 208 monitors and detects whether a user has manually defined a rotation for a specific image. For the latter case, view orientation manager 208 searches for an indication that an HDTV display has been rotated by 90 or 270 degrees and then adjusts the rotation of images displayed to correct for the angular displacement of the display from landscape mode (e.g., 16 by 9) to portrait mode (e.g., effectively 9 by 16). For example, view orientation manager 208 detects that one or more flags are set by a user to indicate that the display is rotated. Optionally, the one or more flags can also indicate the direction of rotation.

Thumbnail resolution manager 210 is configured to optimize the display of one or more thumbnail representations of images. For example, thumbnail resolution manager 210 first detects a degree of resolution associated with each image to be displayed as a thumbnail, and then operates to reduce the amount of data required for displaying a full-size version of the image. This miniaturized image has sufficient detail to enable a user to detect the subject matter associated with the thumbnail. With the reduced amount of image data for each thumbnail, an HD media player according to the present invention can display an array of thumbnail images, such as those depicted as “img” in FIG. 4, without excessive delays due to loading relatively large sized images. In some embodiments, a digital camera or other like device inserts image data into an image file along with a thumbnail image. In this case, thumbnail resolution manager 210 can use the pre-generated thumbnail, which can be internally stored in memory 116 or a portable storage device. This way, the performance of HD player 100 can be enhanced by reducing the time necessary to render images, such as thumbnails.

Smart display manager 212 is designed to show images with minimal “black space” (i.e., the amount of space not used to display an image), unless the images are susceptible to unsatisfactory distortion. Examples of images that are susceptible to distortion include images in portrait mode, and images that are relatively very wide and short. In one embodiment, smart display manager 212 can first compare the actual dimensions of an image to a user-defined tolerance for allowable image distortion. If a degree of distortion is acceptable in accordance with the user-defined tolerance, then smart display manager 212 will redimension the image so as to minimize unused screen space. In another embodiment, smart display manager 212 detects an image type associated with a specific image, where the type of image distinguishes that image, which depicts “nature,” for example, from other image types. In accordance with the detected image type, smart display manager 212 can adjust the dimensions of the specific image to minimize “black space.”

Miscellaneous manager 214 can be any other suitable manager for employing the features of the present invention. For example, miscellaneous manager 214 can operate to coordinate displaying images on a specific HDTV, but in synchronization with other HDTVs, all of which form an array of HDTV displays. For example, each HDTV display of an array of 9 HDTV displays (e.g., 3 by 3) can be controlled to display a unique portion that constitutes 1/9^{th} of an image. Such control can be coordinate by an external computing device via interface one 124 of FIG. 1, for example. In one embodiment, an exemplary HD media player includes an external motion detector manager to detect motion of a user. In this example, miscellaneous manager 214 operates to initialize certain actions, such as a slideshow or a screen saver, when motion is detected in the vicinity of the HD media player.

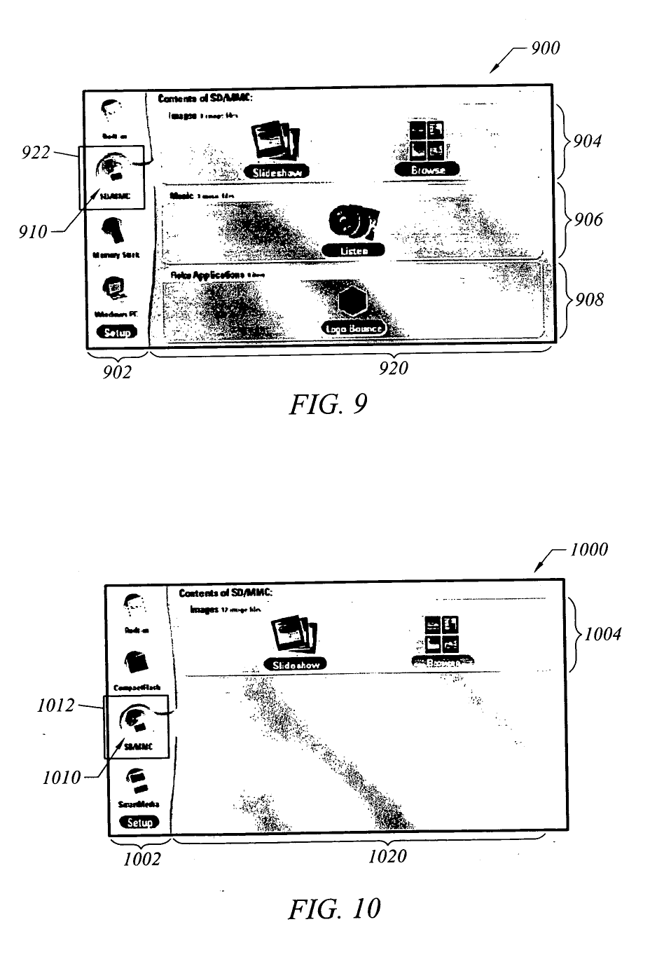

In one embodiment, task view 300 of FIG. 3 can be shown as task view 900 of FIG. 9. Side pane 320 of FIG. 3 can also be shown as side pane 902 of FIG. 9 and can include various selectable icons for representing sources of images, audio, and the like. In this example, the UI-task manager accepts a user input, such as a selected icon 910, which represents an SD/MMC containing images, etc. The UI-task manager and the controller operate to convey information associated with that SD/MMC. The information presented is “context-sensitive.”That is, the UI-task manager will present graphical representations that relate to that specific SD/MMC. In this case, SD/MMC contains images 904, audio 906 and specific program applications 908 (e.g., live art, etc.) that are represented as icons labeled “slideshow,” “Listen,” and “Logo Bounce,” respectively.

As another example, FIG. 10 illustrates a task view 1000 presented upon selection of another source of images. In particular, if icon SD/MMC 1010 is selected in side pane 1002, the related portable storage medium in this case contains only images 1004. These images, which make up contents 1020, are shown to be associated with the icon labeled “slideshow.”

Returning to FIG. 9, the UI-task manager generates a graphical object that indicates that a specific source of images, for example, is selected and describes the contents of that source. In this example, graphical object 922 includes an object that surrounds the selected icon (e.g., icon 910) and visually connects that icon to the contents 920 of the source of images, such as SD/MMC. As shown, content 920 is shown in a region that is perceptibly separate from side pane 902, coupled only to icon 910 by the object. As shown in FIG. 10, graphical object 1012 surrounds icon 1010 and visually connects that icon to a region describing contents 1020. In other embodiments, the graphical object can have any of a number of shapes.

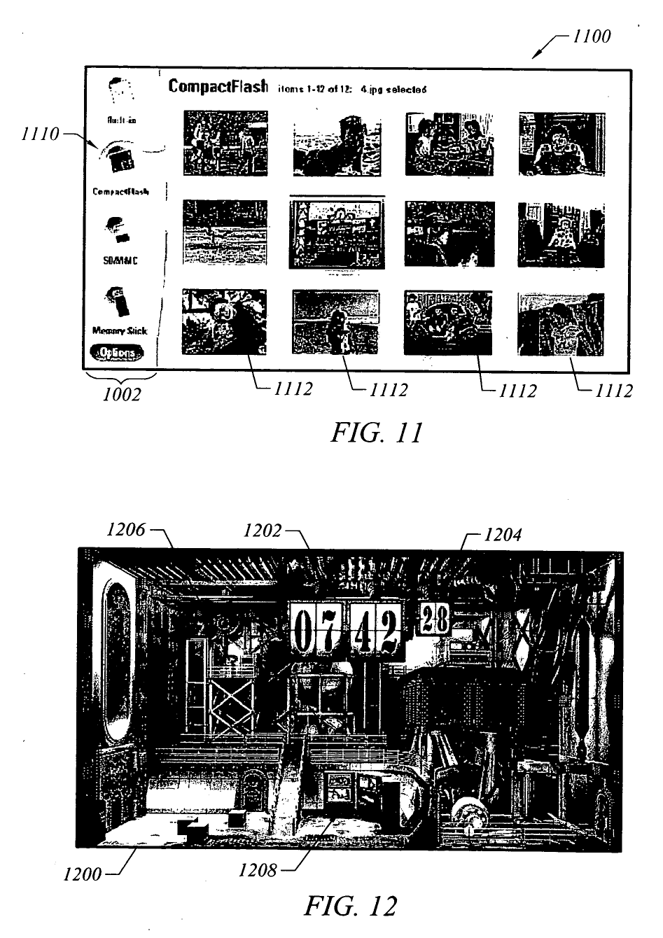

FIG. 11 shows another task view 400 of FIG. 4, according to another embodiment. In this example of task view 1100, icon 1110 of side pane 1102 is shown to be selected. A graphical object depicts the relationship to the contents of the source of images related to icon 1110. Here, compact flash is shown to include any number of thumbnail images 1112.

In another embodiment of the present invention, HD media player 100 of FIG. 1 is configured to present programmatically generated animations that depict motions based on or in response to, for example, one or more events related to the animation. In one specific method of creating programmatically generated animations, an animator or the like generates a first HD video clip, such as an HDMPEG clip that depicts a programmatically generated scene. The first video clip is configured to repeat, or loop, periodically. A second video clip is created and then configured to replace the first video clip shown on an HD display upon some event. A graphics plane depicting another animation, which is independent of the first and the second video clips, is overlaid on the video of the two clips. This graphics plane includes overlaid animation that can be programmatically generated as a HDMPEG clip. When an event related to the another animation (i.e., the overlaid animation) occurs, then the second video replaces the first.

As an example, FIG. 12 is a screen shot 1200 shows a scene of programmatically generated animation. Consider that a first video clip is looping and shows an object, such as a graphical representation of a robot, located at “X” 1206. During the presentation of this animation, another animation showing images 1202 and 1204 is overlaid upon the display of the first video. Images 1202 and 1204 combine to show the time. Upon an event, such as a repeated time interval (e.g., every hour) or when a preset alarm goes off, the first video is seamlessly replaced with a second HD MPEG (or the like). In the second HD video, the object can be shown moving to location “X” 1208. Thereafter, the second video either continues looping until another event occurs, or the object moves elsewhere, as depicted in a third HD video clip. One having ordinary skill in the art should appreciate that other animations other than time-keeping are within the spirit and scope of the invention.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A media player comprising:
a high definition output terminal configured to communicate a high definition video signal to a high definition display;
at least one port configured to receive portably-stored content from a portable storage device; and
a controller coupled to the at least one port and to the high definition output terminal, the controller configured to select an image file from the portably-stored content and to generate at least a portion of a high definition image on the high definition display.

2. The media player of claim 1 further comprising a screen saver module configured to monitor the high definition video signal.

3. The media player of claim 2 wherein the screen saver module communicates one or more screen saver images for presentation on the high definition display when the high definition video signal is substantially absent.

4. The media player of claim 2 wherein the screen saver module communicates one or more screen saver images for presentation on the high definition display when a degree of motion associated with the portion of the high definition image is outside a range of motion.

5. The media player of claim 4 wherein the range of motion is defined by a number of pixels associated with the portion of the high definition image, each of the number of pixels sufficiently depicting motion.

6. The media player of claim 1 further comprising a media insertion manager module configured to automatically present the portion of the high definition image after the image file is discovered.

7. The media player of claim 6 wherein the image file is an auto-run file.

8. The media player of claim 1 further comprising a light sensor module configured to detect a level of brightness and selectively alter characteristics of the high definition image.

9. The media player of claim 1 further comprising a view orientation manager module configured to orient the display of the high definition image.

10. The media player of claim 1 further comprising a thumbnail resolution manager module configured to reduce the amount of data required to present a miniaturized high definition image.

11. The media player of claim 1 further comprising a smart display manager module configured to minimize an amount of space not used to display the high definition image.

12. The media player of claim 1 wherein the portable storage device is a compact flash card.

13. A method of presenting a high definition image comprising:
detecting the presence of portably-stored content;
determining whether one or more media files of the portably-stored content are auto-run media files;
identifying that the one or more media files are auto-run media files; and
presenting on a high definition display at least one high definition image associated with the one or more media files.

14. The method of claim 13, further comprising:
identifying that no media file of the portably-stored content is an auto-run media file; and
presenting on the high definition display at least one high definition image of the portably-stored content if the portably-stored content includes only image files.

15. The method of claim 14, further comprising presenting audio to a user with one or more other high definition images on the high definition display if the portably-stored content includes only audio files.

16. The method of claim 15, wherein the one or more other high definition images are programmatically generated by a visualizer.

17. The method of claim 15 further comprising:
identifying a mix of image and audio files of the portably-stored content; and
presenting a task view user interface on the high definition display.

18. The method of claim 13 further comprising:
receiving a user input;
aborting the presentation of the at least one high definition image; and
presenting a task view user interface on the high definition display.

19. The method of claim 18 further comprising:
selecting to browse the at least one high definition image;
adjusting a number of pixels constituting the at least one high definition image; and
generating a thumbnail representation from the adjusted number of pixels.

20. The method of claim 13 further comprising adjusting a dimension of the at least one high definition image to reduce an unused amount of the high definition display.

21. The method of claim 13 further comprising rotating the at least one high definition image.

22. A media player for presenting images on a high definition television screen comprising:
means for receiving a portable storage device including at least one media file designated as an auto-run file;
means for generating a high definition output video signal to present one or more screen saver images on the high definition television screen; and
means for presenting on the high definition television screen a high definition image from the portable storage device.

23. The media player of claim 22 further comprising means of adjusting a brightness level of the high definition display in response to an amount of light illuminating the environment of the high definition television screen.

24. The media player of claim 22 wherein the means for presenting further comprises means for performing a slideshow including the high definition image and other high definition images, wherein at least one of the high definition image and the other high definition images is presented having a first portion depicted as having no motion and a second portion depicted as having motion.

25. The media player of claim 22 further comprising a view orientation means to present the high definition image in an optimal orientation, the view orientation means including:
means for detecting an indicator that specifies the view orientation of the high definition image;
means for orientating the high definition image in accordance with the indicator; and
if no indicator is detected, means for presenting a user interface to accept inputs to orientate the view.

26. A system for displaying electronic art comprising:
a high definition (“HD”) display; and
a HD media player coupled to the HD display and configured to receive portably stored content on a computer readable medium, the computer readable medium including
instructions for generating a first HD video on the HD display,
instructions for generating a second HD video on the HD display,
instructions for generating an overlaid animation,
instructions for providing an event indicator to indicate that an event associated with the overlaid animation has occurred, and
instructions for switching from the first HD video to the second HD video upon detecting the event indicator.

27. The system of claim 26 wherein overlaid animation is a clock.
